(19) United States
(12) Patent Application Publication
(10) Pub. No.: US 2009/0283983 A1
(43) Pub. Date: Nov. 19, 2009

(54) Wheelchair construction

(76) Inventor: Gregor Horacek, Ransbach-Baumbach (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/387,522

(22) Filed: May 4, 2009

(30) Foreign Application Priority Data
May 19, 2008 (EP) 08009192.9

(51) Int. Cl. B62M 1/14

(52) U.S. Cl. 280/250.1

(57) ABSTRACT

A wheelchair construction has an undercarriage with lateral struts, a rear axle and a seat. A pair of connection adapters are connected with the lateral struts and the rear axle, and have a circular arc-shaped portion. A pair of seat supports are connected with the seat, and have a circular arc-shaped portion which mates with, is received in, and is supported by the circular arc-shaped portion of the connection adapters to facilitate selected angular shifting of the seat supports relative to the connection adapters for adjusting the tilt angle of the seat.

### CLAIM OF PRIORITY

Applicant hereby claims the priority benefits under the provisions of 35 U.S.C. §119, basing said claim of priority on European Patent Application Serial No. 08 009 192.9, filed May 19, 2009. In accordance with the provisions of 35 U.S.C. §119 and Rule 55(b), a certified copy of the above-listed European patent application will be filed before grant of a patent.

### BACKGROUND OF THE INVENTION

The present invention relates to wheelchairs, and in particular to a wheelchair construction adaptable for either an active user wheelchair or a push wheelchair.

In contrast to folding wheelchairs, active user wheelchairs, in particular so-called rigid frame wheelchairs, are intended for users who primarily operate the wheelchair themselves. In other words, active wheelchairs are intended for users who actively operate them without assistance from others. High demands are placed on these wheelchairs in terms of how they can be adjusted or customized for patients, especially with regard to the patient's position relative to the rear axle. Preferably, it should be possible to adjust the wheelchair, so as to position the patient's shoulders over the axle of the drive wheels. This requires that it be possible must to adjust the position of the rear axle and seat, and therefore the position of the horizontal seat surface and the seat back, horizontally relative to one another. However, the seat angle relative to the horizontal also plays a major role in the active position, and must also be adjustable for the individual user. As a rule, the rear seat edge is preferably lower than the front seat edge. Wheelchair designs with connection adapters for the frame tubes, rear axle, and seat supports are known in the art. The seat supports are typically tubular. The “Blizzard” active wheelchair from the Otto Bock company (www.ottobock.de, 15 May 2008) uses a milled part that connects the seat tube to the rear axle. The seat tube is also the frame tube. The steerable front casters, for instance, are mounted to the seat tube. In order to adjust the rear axle relative to the seat back, the milled part on the seat tube/frame tube is moved and securely clamped thereto. However, this adjustment also changes the wheel base and the seat angle. The seat angle relative to the horizontal is set by moving the rear axle on the milled part. This also changes the angle of the frame tube on which the front casters are mounted, making it necessary to readjust the casters to a vertical orientation on the steering fork axis. This type of wheelchair requires a corresponding device for clamping the round journal bearing in the steering fork element. These repositioning and adjustment processes are complex, and frequently result in the steering forks being set incorrectly. There is also the disadvantage that when the seat angle is adjusted in this manner, the pivot point/fulcrum is adjacent the front caster axle. This means that, when the angle is changed, the center of gravity moves rearward, and there is an increased risk of tipping.

The “Knuffi O1” wheelchair from the Sorg Company (www.sorgrollstuhltechnik.de, 15 May 2008) is an active wheelchair designed for children and youths. It has connection adapters in the form of metal sheet blanks that are welded to the rear axle. Both the frame parts of the undercarriage and the elements of the seat are mounted to these metal sheet blanks, which are oriented vertically. Adjusting the seat angle is not possible at all, or only a very slight amount by varying the relative sizes of the rear wheels and the front casters. The welded design of the metal sheet blank axle tube is another disadvantage. This weld must be made along each seat width (generally from approximately 20 centimeters to approximately 40 centimeters, in 2 centimeter increments).

### SUMMARY OF THE INVENTION

One object of the present invention is to create a wheelchair in which it is possible to adjust the rear axle relative to the seat back, and to adjust a seat angle quickly and simply without having to change the geometry of the undercarriage or the position of the patient's center of gravity relative to the rear axle. Moreover, it should also be possible to adjust the wheel base and the height of the seat relative to the rear axle.

The present invention suggests a wheelchair, in particular an active wheelchair, having connection adapters that are connected to lateral struts for the undercarriage, to the rear axle, and to the supports for the wheelchair seat. Each connection adapter has a circular arc-shaped portion or contour for receiving a seat support that has a corresponding circular arc-shaped portion or contour.

Each connection adapter in its upper area is advantageously provided with a recess. The recess has a circular arc-shaped contour, and the seat support is provided with the circular arc-shaped contour at its lower area. The weight of the person sitting on the wheelchair is thus passed directly via each seat support to its associated connection adapter.

The connection adapters can preferably be moved or adjusted for setting the wheel base on the lateral struts.

It is considered a particular advantage when each connection adapter is supported in a height adjustable manner relative to the rear axle. In addition, each seat support should be supported in a height adjustable manner relative to the connection adapter, and/or the seat should be supported in a height adjustable manner relative to the seat supports. It is furthermore advantageous when the seat is borne horizontally adjustable relative to the seat supports. Using these measures, it is possible to adapt the wheelchair optimally to the ergonomic requirements of the person using the wheelchair.

Each seat support may be embodied generally like a plate. Each seat support is formed by at least one plate, in particular by the plate and a bracket attached thereto for supporting the seat. The seat supports are particularly simple to produce because of this configuration. In addition, using a special configuration, in particular by providing it with slots and holes, the plate can also have other functions in addition to the specific function of supporting the seat.

For instance, it is provided that the bracket is mounted in at least one longitudinal slot or in longitudinal slots. The bracket is fastened to the plate by a fastener. The plate preferably has at least two longitudinal slots that are arranged parallel to one another. Thus, a largely horizontal relative adjustment between bracket and plate is possible in the longitudinal direction of the longitudinal slot or slots. This enables relative adjustment of seat and seat supports. Moreover, it is conceivable to configure the plate such that it has at least two longitudinal slots that are arranged parallel to one another. This makes it possible to position the support plate at different heights.

In accordance with one embodiment of the present invention, the connection adapter comprises two separate parts that are disposed perpendicularly to the rear axle. Configuring the connection adapter in this manner makes it possible to arrange functional parts between the two connection adapter parts, and to position, connect or lock the same differently in that location.

In one embodiment of the present invention, the connection adapter has at least one through hole for receiving a clamping element or a locking unit in order to fix the seat support in a selected position. The clamping element makes it possible to fix the seat support relative to the connection adapter with the seat support in any position. The locking unit permits the seat support to be fixed in any one of a variety of predefined positions.

The seat support preferably has in its lower area at least one longitudinal slot extending across a circular arc for adjusting the seat angle. The longitudinal slot aligns with at least one bolt hole and at least one through hole for the clamping unit. In accordance with one preferred embodiment of the present invention, the seat support has, especially in its lower area, a plurality of holes arranged across a circular arc for locking with a lock unit on the adapter side.

In accordance with one preferred structural configuration of the present invention, the connection adapter, especially one part of the adapter, has a recess for receiving a circular arc-shaped guide rail. This guide rail is most suitable for supporting the relatively high forces that are introduced into the seat via the person sitting in the wheelchair. Consequently, the guide rail is preferably constructed from metal. The connection adapter may be made from plastic, or the like. This configuration of the guide rail that is supported in the recess of the connection adapter makes it possible to support and guide the seat supports in a particularly uncomplicated simple manner. Thus, the guide rail preferably passes through a circular arc-shaped groove in the seat support. This groove in the seat support is significantly longer than the guide rail. Thus, the guide rail can be moved between the two ends of the longitudinal slot in the seat support, so as to position the seat at different angles of inclination.

It is particularly intended that the seat support can be pivoted about an angle of up to 50 degrees, in particular about an angle to the horizontal of −5 degrees to +15 degrees or −5 degrees to +45 degrees, relative to the connection adapter. In the former case, wherein the ability to pivot is about a relatively narrow angle, the same is particularly advantageous for use in an active wheelchair. The wider angle adjustment range is preferably used when the wheelchair is not an active wheelchair.

Additional features of the invention are depicted in the claims, the description of the figures, and in the figures themselves. It should be noted that all individual features and all combinations of individual features represent further inventive embodiments.

### BRIEF DESCRIPTION OF THE DRAWINGS

The invention is shown in the figures as two different exemplary embodiments. The invention shall not be limited to these embodiments, however.

FIG. 1 is a perspective elevation of a first embodiment of the present invention, in the form of an active wheelchair, wherein the seat is shown without seat cushions.

FIG. 2 is a perspective elevation of the wheelchair illustrated in FIG. 1, without the seat;

FIG. 3 is a side view of the wheelchair illustrated in FIG. 2;

FIG. 4 is an exploded depiction of the wheelchair illustrated in FIGS. 2 and 3;

FIG. 5 is an exploded depiction of the wheelchair illustrated in FIGS. 1-4, particularly showing the lateral strut, connection adapter, and rear axle connect;

FIGS. 6 and 7 depict side and rear views of one part of the connection adapter shown in FIG. 5;

FIGS. 8 through 10 depict a side view, a rear view, and a section according to line B-B in FIG. 8 through the other part of the connection adapter;

FIG. 11 is a side view of the seat support used in the wheelchair illustrated in FIGS. 1-10;

FIG. 12 is a perspective view of a second embodiment of the present invention, which is configured as a push wheelchair, wherein the seat is shown without seat cushions;

FIG. 13 is a perspective view of the wheelchair shown in FIG. 12, without the seat;

FIG. 14 is a side view of the wheelchair illustrated in FIG. 13;

FIG. 15 is a side view of the wheelchair illustrated in FIG. 14, with the seat supports tilted to the rear;

FIG. 16 is an exploded depiction of the wheelchair illustrated in FIGS. 12-15, particularly showing lateral struts with front casters, connection adapters, seat supports, rear axle, and their bearing elements;

FIG. 17 is an exploded depiction of the wheelchair illustrated in FIGS. 12-16, particularly showing the lateral strut, the connection adapter, and the rear axle; and

FIGS. 18 and 19 are side views of the seat supports used in the wheelchair illustrated in FIGS. 12-17.

In the description that follows, the common features of the active wheelchair and the push wheelchair are referenced by the same numerals.

### DETAILED DESCRIPTION OF THE PREFERRED EMBODIMENTS

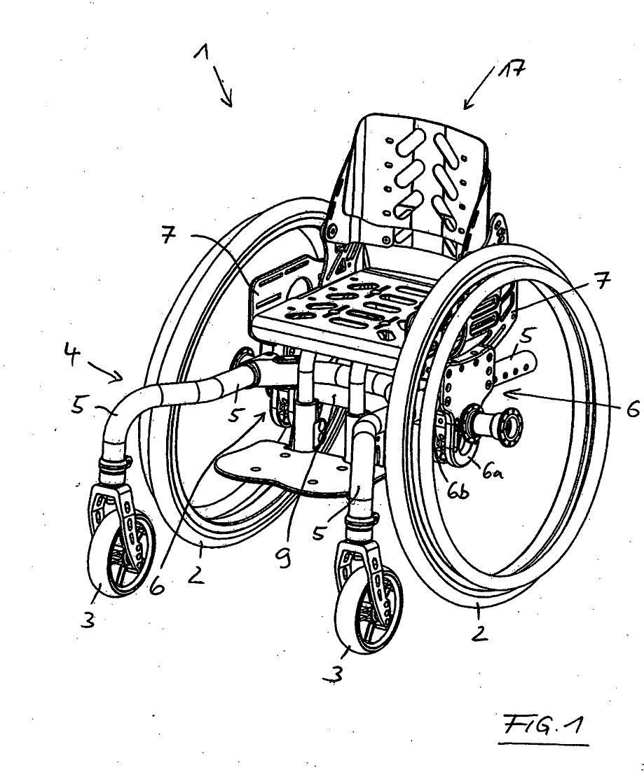

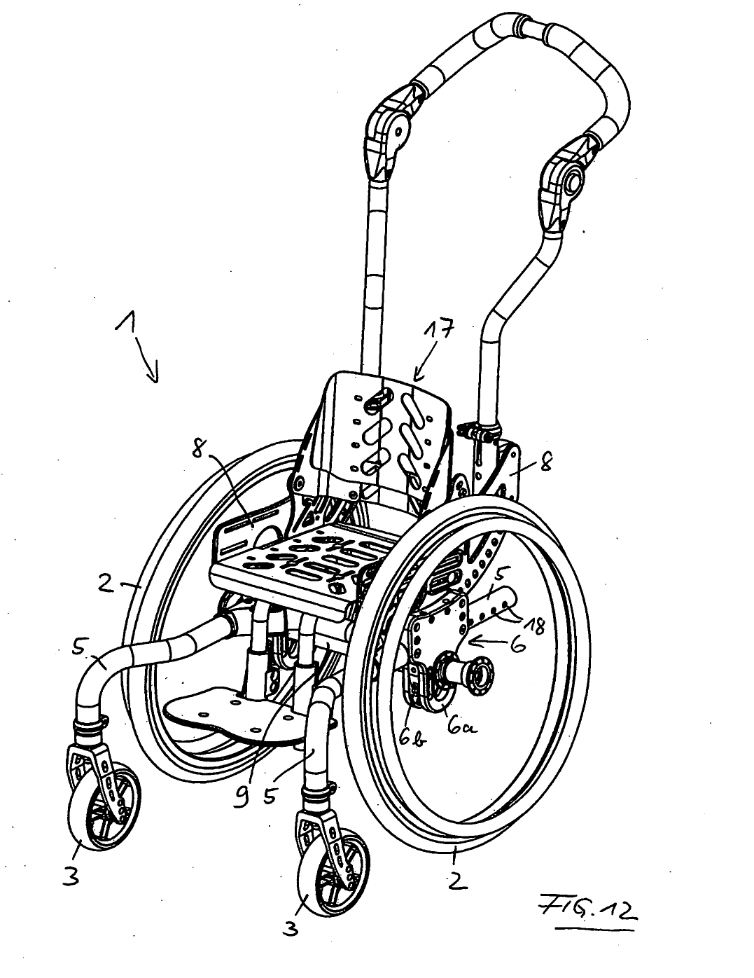

For purposes of description herein, the terms “upper”, “lower”, “right”, “left”, “rear”, “front”, “vertical”, “horizontal” and derivatives thereof shall relate to the invention as oriented in FIGS. 1 and 12. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

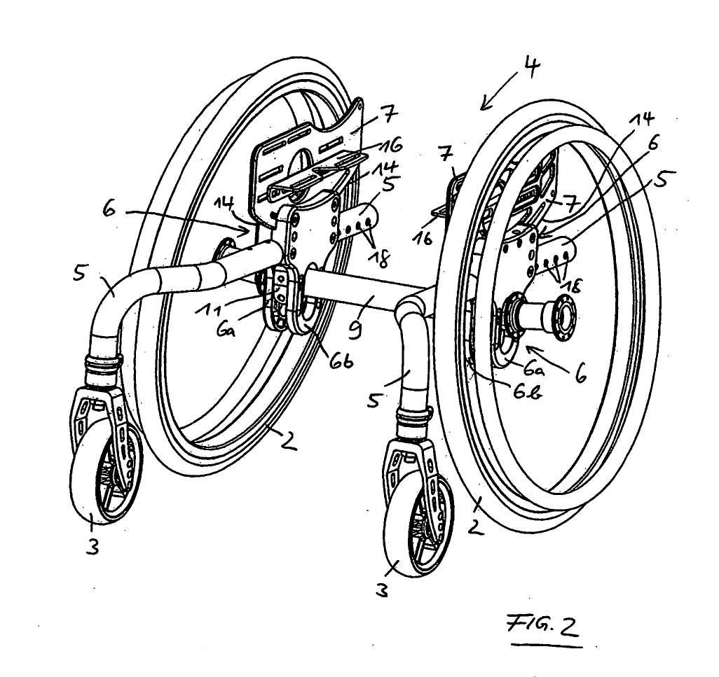

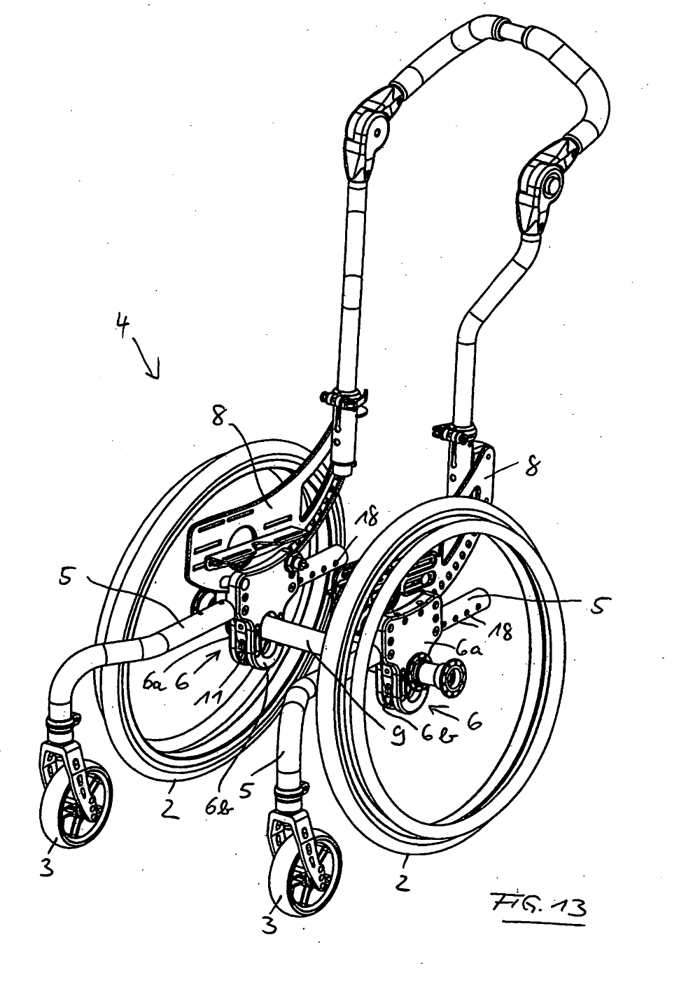

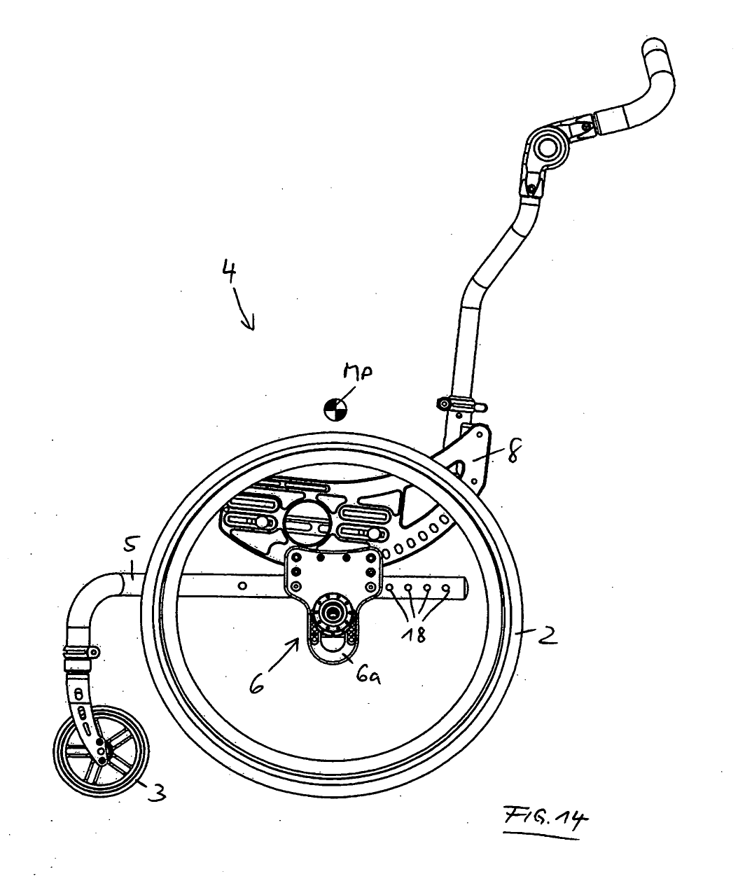

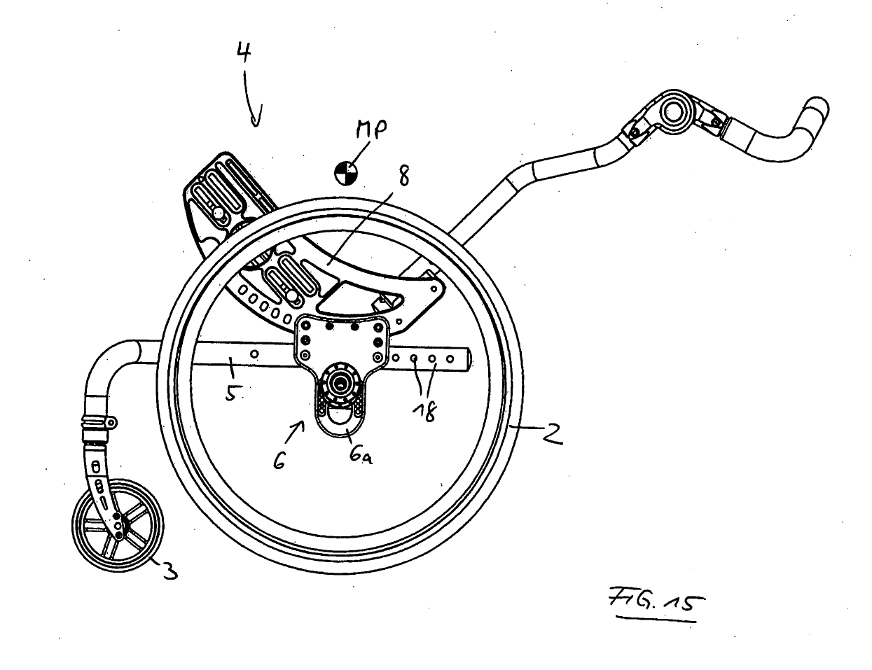

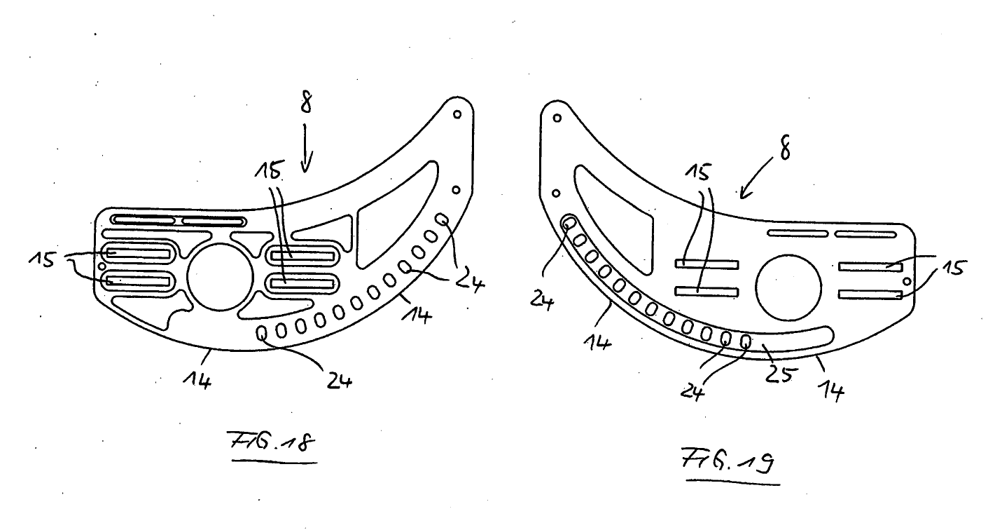

The figures illustrate a wheelchair 1 with two drive wheels 2, two steerable front casters 3, and an undercarriage 4 that has lateral struts 5. Attached thereto are connection adapters 6 that can be adjusted longitudinally. The latter are for adjusting the desired wheel base, two different style seat supports 7 (FIGS. 1-11) and 8 (FIGS. 12-19), and the rear axle 9.

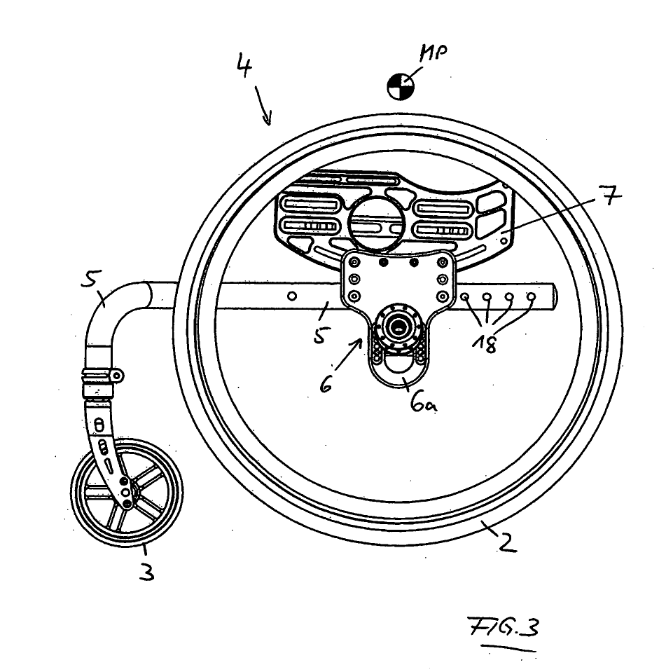

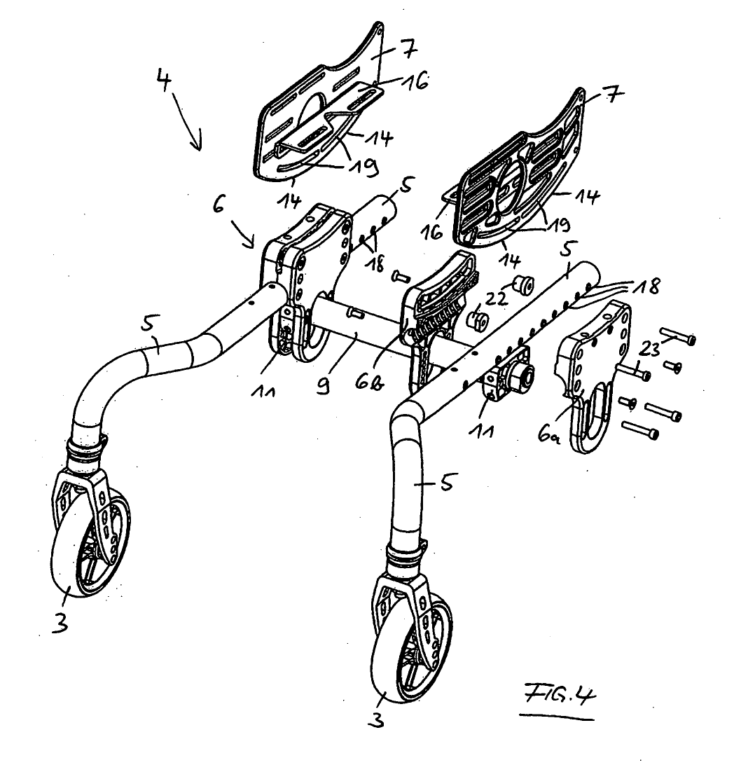

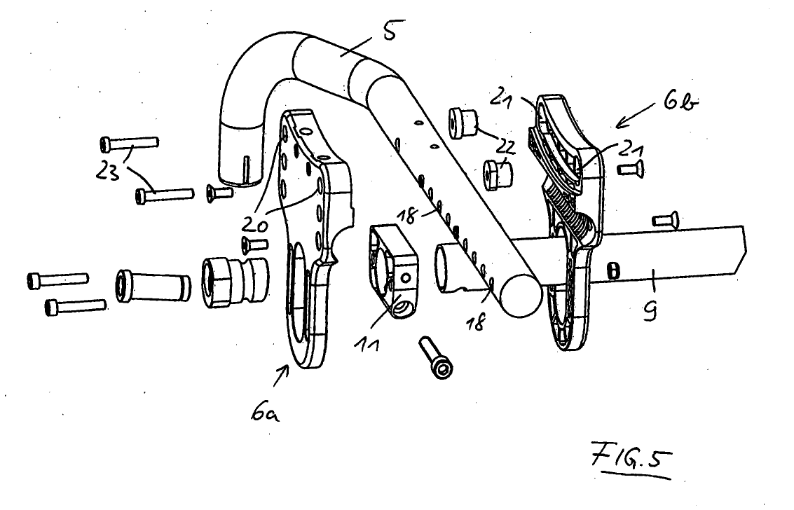

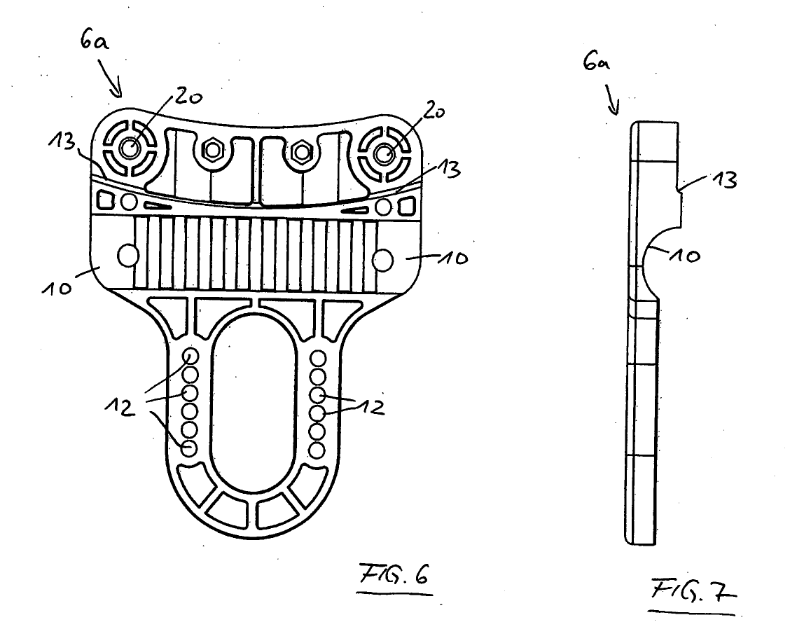

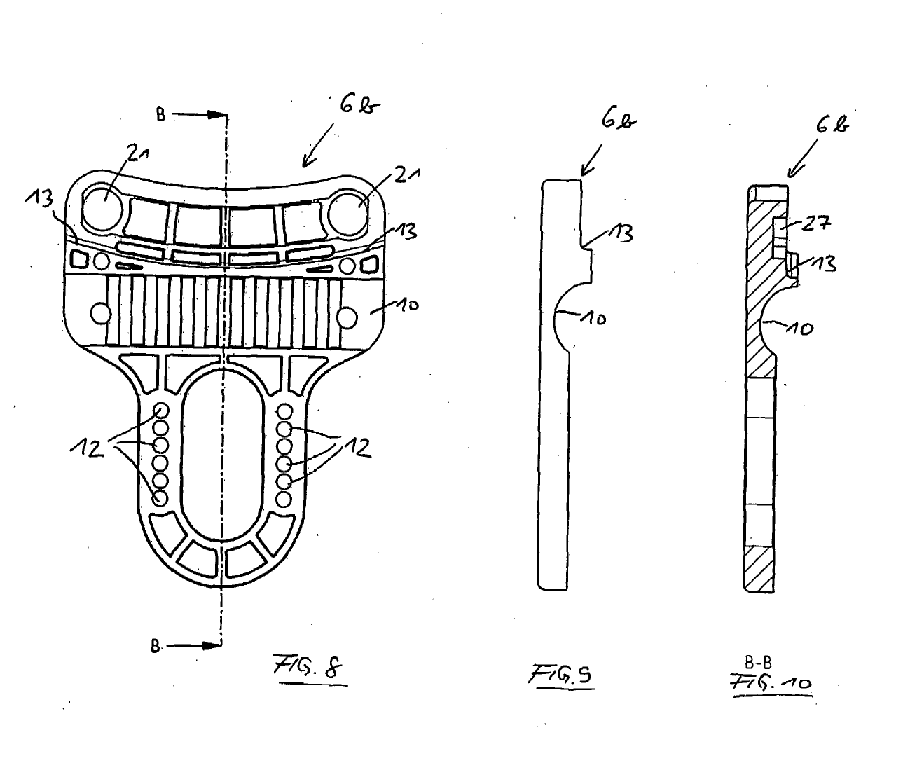

Each connection adapter 6 (FIG. 5) preferably comprises two adapter parts: the outer adapter half or part 6a and the inner adapter half or part 6b. The plane of separation between adapter parts 6a and 6b runs generally perpendicular to the rear axle 9, and also preferably runs through the center line of the lateral struts 5. The adapter parts 6a and 6b each have a depression 10 (FIGS. 6 and 7) that corresponds to the diameter of the lateral struts 5, so that there is a positive fit connection to the lateral struts 5. The rear axle 9 is received in the connection adapters 6 below the lateral struts 5 by position adapters 11 (FIG. 4). A series of holes 12 (FIGS. 6-10) in the adapter parts 6a and 6b make it possible to adjust the height of the rear axle. The seat supports 7 (FIGS. 1-11) and 8 (FIGS. 12-19) are received and rotatably supported or borne in the connection adapters 6 above the lateral struts 5. The seat supports 7 (FIGS. 1-11) and 8 (FIGS. 12-19) are both preferably plate-like. Each adapter part 6a and 6b has in its upper area a circular arc-shaped portion or recess 13 (FIGS. 8-10) that corresponds to the plate thickness. Conforming to these circular arc-shaped recesses, the seat supports 7 (FIGS. 1-11) and 8 (FIGS. 12-19) also have a circular arc-shaped portion or contour 14 (FIG. 4) in their lower area. The seat supports 7 (FIGS. 1-11) and 8 (FIGS. 12-19) rotate or pivot in the connection adapters 6 in that the radial surface of the circular arc-shaped contour 14 slides on the radial surface of the circular arc-shaped recesses 13. The point of rotation “MP” (FIG. 3) is the center point of the circle. Preferably, the center point “MP” should come as close as possible to the center of gravity of the patient/seat system.

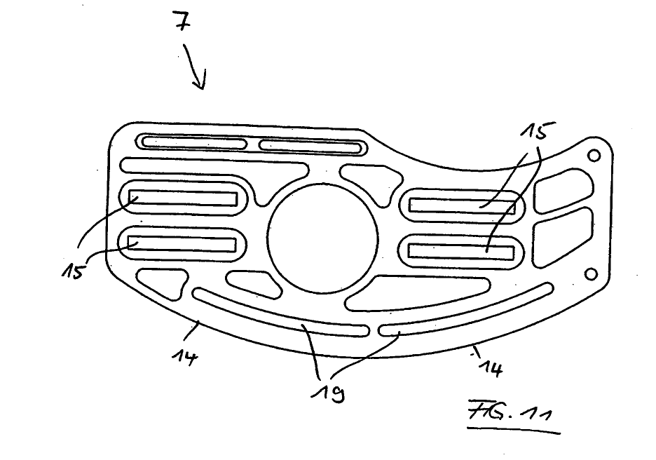

Two longitudinal slots 15 (FIG. 11) in each seat support 7 (FIGS. 1-11) and 8 (FIGS. 12-19) receive brackets 16 that can be displaced longitudinally and that are for fastening seat surfaces or seats 17. Thus, without changing the geometry of the undercarriage, it is possible to adjust seat 17 horizontally relative to the rear axle 9, in order to be able to achieve an optimum position, especially an optimum position for actively operating the wheelchair. Two sets of longitudinal slots 15 are positioned one above the other so that further variation in the seat height is possible.

The connection adapters 6 can be moved on the lateral struts 5 corresponding to the apertures or bores 18 in order to set a certain wheel base. Purely non-positive fit clamping or attachment to the lateral struts is also conceivable.

Both the seat angle and the horizontal distance from the rear axle 9 to the rear surface of the seat 17 are maintained.

The following discussion relates to the two different variants of seat supports 7 (FIGS. 1-11) and 8 (FIGS. 12-19) and how they are fixed or mounted on the connection adapters 6.

The seat supports 7 are provided for the active wheelchair 1 illustrated in FIGS. 1 through 11. In this wheelchair, the seat support is to be set or slidingly adjusted in infinitesimally small increments along a specific, relatively narrow range of angles (approximately −5 degrees to +15 degrees) relative to the horizontal. In their lower area, near and parallel to the circular arc-shaped contour 14, the seat supports 7 have two (where necessary more, but at least one) radial longitudinal slots 19 (FIGS. 4 and 11) that are separated by a thin bar for stabilization. These longitudinal slots 19 are aligned with bolt holes 20 (FIG. 5) in the outer adapter parts 6a and through holes 21 in the inner adapter parts 6b. A clamping element 22 is positioned or borne in each through hole 21, such that the clamping element 22 is rotatably fixed or rotation-fast, but can be displaced longitudinally in the through holes 21. Bolts 23 in the bolt holes 20 penetrate the radial longitudinal slots 19 (securing the seat supports 7), and are screwed into the clamping elements 22. This causes the clamping elements 22 to tighten against the seat supports 7 and clamp against the outer adapter parts 6a. Loosening the bolts 23 releases the seat supports 7, so that they can slide pivotally in the recesses 13. For adjusting a seat angle that is stable against tilting, and produces less rolling resistance that saves user energy, it is important for the radius of the recesses 13 and the contour 14 of seat support 7 to be selected such that the center point “MP” (FIG. 3), or the point of rotation, is as close as possible to the center of gravity of the patient/seat system. That is, the center point “MP” should be located above the seat surface and in front of the seat back. To simplify the design and the adjustment process, the location of the center point “MP” is not defined more precisely.

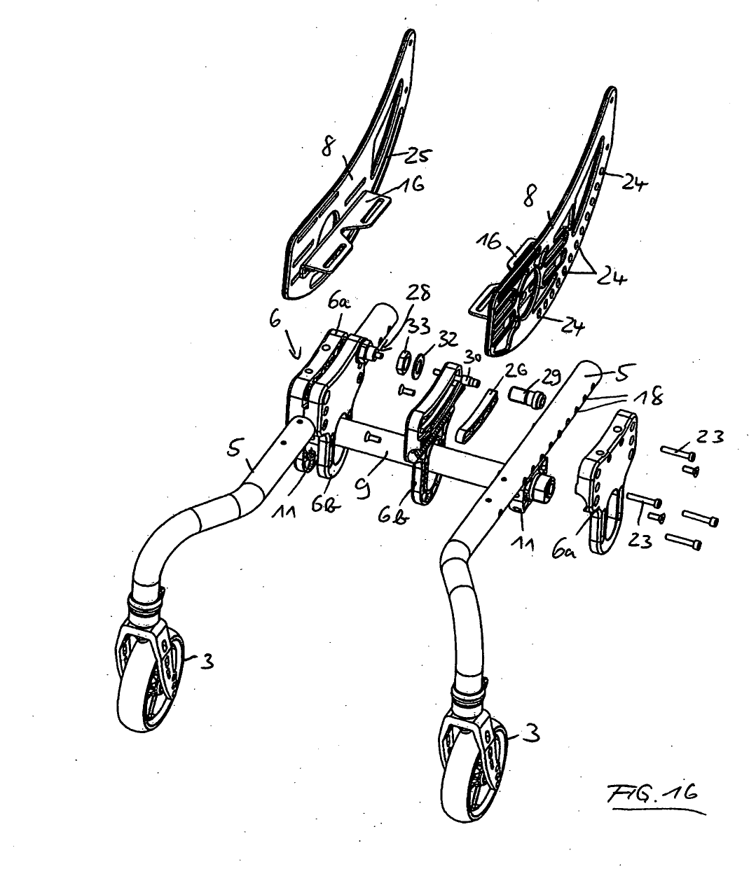

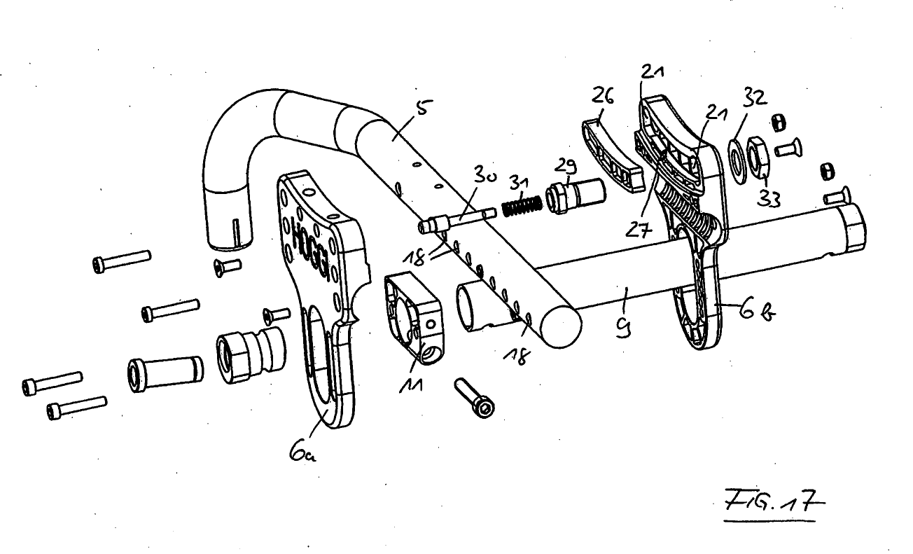

In a wheelchair in accordance with the embodiment in FIGS. 12 through 19, a push wheelchair, the seat supports 8 are used when the tilt of the seat support is to be adjusted or altered in discrete increments over a wider range of angles (approximately −5 degrees to +45 degrees). In their lower area, near and parallel to the circular arc-shaped contour 14, the seat supports 8 have a series of radially arranged holes 24, and on one side have an approximately four millimeter deep radial groove 25 that extends across the area of the holes 24 and beyond them in a forwardly direction. One half of a guide rail 26 (FIGS. 16 and 17) is supported or borne in a recess 27 of the inner adapter part 6b, and the other half is supported or borne in the groove 25 of the seat support 8, thereby preventing the seat supports 8 from escaping from the connection adapters 6. Each seat support 8 is retained in one of the holes 24 corresponding to the desired adjusted seat angle by means a locking element 28 (FIGS. 16 and 17) that comprises a lock housing 29, a lock 30, a compression spring 31, a washer 32, and a nut 33. The locking elements 28 are each preferably screwed into the rear through holes 21 of the inner adapter parts 6b. The associated release mechanism is not depicted in order to facilitate visualization.

Seat angle adjustment is facilitated by angle-settable or angle-adjustable guidance and fixation of the seat supports 7 and 8 relative to the connection adapters 6. It is not necessary to change the geometry of the undercarriage 4, or the position of the user's center of gravity relative to the rear axle 9.

The connection adapters 6 do not necessarily have to be designed as depicted, with the rear axle 9 located below the lateral struts 5. An arrangement above the lateral struts 5 is also conceivable, in which case the seat surface would be positioned closer to the rear axle 9 and the user would be lower between the drive wheels 2. Nor is it absolutely necessary for the rear axle 9 to be designed as continuous. Drive wheels 2 could also be removably or fixedly attached directly to the position adapter 11.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is as follows:

1. In an active wheelchair having an undercarriage with lateral struts, a rear axle and a seat, the improvement comprising:
a pair of connection adapters, each operably connected with said lateral struts and said rear axle, and having a circular arc-shaped portion; and
a pair of seat supports, each operably connected with said seat, and having a circular arc-shaped portion which mates with and is received in and supported by said circular arc-shaped portion of an associated one of said connection adapters to facilitate selected angular shifting of said seat supports relative to said connection adapters for adjusting the tilt angle of said seat.

2. A wheelchair as set forth in claim 1, wherein:
said circular arc-shaped portion of each of said connection adapters is disposed in an upper portion thereof and comprises a recess; and
said circular arc-shaped portion of each of said seat supports is disposed in a lower portion thereof.

3. A wheelchair as set forth in claim 2, wherein:
said connection adapters are supported on said rear axle for vertical adjustment.

4. A wheelchair as set forth in claim 3, wherein:
said seat supports are supported on said connection adapters for vertical adjustment.

5. A wheelchair as set forth in claim 1, wherein:
said seat is supported on said undercarriage for horizontal adjustment.

6. A wheelchair as set forth in claim 1, wherein:
said seat supports each include at least one plate member and one bracket member on which said seat is supported.

7. A wheelchair as set forth in claim 6, wherein:
said plate member includes at least one longitudinal slot or a plurality of holes through which fasteners extend to adjustably connect said bracket member to said plate member.

8. A wheelchair as set forth in claim 6, wherein:
said plate member includes first and second slots arranged either parallel or successively, through which fasteners extend to adjustably connect said bracket member with said plate member.

9. A wheelchair as set forth in claim 1, wherein:
said connection adapters each have a two-part construction with a joint therebetween oriented generally perpendicular to said rear axle.

10. A wheelchair as set forth in claim 1, wherein:
said connection adapters each have at least one through hole in which either a clamping element or a locking unit is mounted for locking said seat supports in place.

11. A wheelchair as set forth in claim 1, wherein:
said seat supports each have lower portions with at least one longitudinal slot extending along a circular arc for adjusting said tilt angle of said seat; and
said connection adapters each have at least one bolt hole and at least one through hole which are aligned with said longitudinal slot and receive a clamping unit therethrough.

12. A wheelchair as set forth in claim 1, wherein:
said seat supports each have a lower portion with a plurality of apertures extending along a circular arc for adjusting said tilt angle of said seat; and
said connection adapters each have at least one bolt hole and at least one through hole which are aligned with one of said apertures through which a locking member is received.

13. A wheelchair as set forth in claim 1, wherein:
said connection adapters each have an inner half with a recess; and including
a circular arc-shaped guide rail mounted in said recess of said inner half of each of said connection adapters.

14. A wheelchair as set forth in claim 13, wherein:
said seat supports each have a circular arc-shaped groove in which said guide rail is received and retained.

15. A wheelchair as set forth in claim 14, wherein:
said seat supports are constructed to permit said tilt angle of said seat to shift between a range of −5 degrees to +45 degrees relative to the horizontal.

16. A wheelchair as set forth in claim 1, wherein:
said connection adapters are adjustably supported on said lateral struts to facilitate varying the position of said wheels.
